(19) United States
(12) Patent Application Publication
(10) Pub. No.: US 2018/0015816 A1
(43) Pub. Date: Jan. 18, 2018

(54) PARALLEL-SHAFT TRANSMISSION ASSEMBLY WITH SELECTABLE ELECTRIFICATION

(71) Applicant: GM GLOBAL TECHNOLOGY OPERATIONS LLC, Detroit, MI (US)

(72) Inventors: Darrell L. Robinette, Dollar Bay, MI (US); Tejinder Singh, Commerce Township, MI (US)

(73) Assignee: GM GLOBAL TECHNOLOGY OPERATIONS LLC, Detroit, MI (US)

(21) Appl. No.: 15/208,101

(22) Filed: Jul. 12, 2016

(51) Int. Cl. B60K 6/36; F16H 3/00; B60K 6/445; F16H 37/08; F16H 3/091

(52) U.S. Cl. CPC B60K 6/36; F16H 37/0806; F16H 3/091; B60K 6/445; F16H 3/006; B60Y 2300/73; B60Y 2300/80

(57) ABSTRACT

A transmission assembly for mounting to an external power-source includes an input shaft configured to receive power-source torque. The transmission assembly also includes an output member configured to transmit a transmission output torque to drive a load. The transmission assembly additionally includes a countershaft driven by and arranged parallel to the input shaft. The countershaft has a first gear-set rotatably mounted thereon and is configured to drive the output member. The transmission assembly also includes a second gear-set in mesh with the first gear-set and operatively connected to the output member. Furthermore, the transmission assembly includes an electric motor configured to be selectively connected to the input shaft via a first torque transfer device and to the output member via a second torque transfer device to thereby provide a variable electric motor internal torque input to the transmission assembly. A vehicle having such a transmission and power-source is also disclosed.

### TECHNICAL FIELD

The disclosure relates to a motor vehicle parallel-shaft transmission assembly having a selectable connection for an internal electric motor.

### BACKGROUND

A typical manual transmission for a motor vehicle has several parallel shafts with various gears and other components attached to them. Generally, a rear-wheel-drive manual transmission has three shafts: an input or driving shaft that carries input torque into the transmission, a countershaft or layshaft, and a driven or output shaft that carries torque out of the transmission. The countershaft is an intermediate shaft mounted within the transmission assembly in parallel with the input and output shafts and carries a cluster of transmission gears of various sizes. The countershaft gears are caused to rotate by a rotation of the input shaft, but do not transfer the primary drive of the transmission either into or out of the transmission. In general, the countershaft gears may either turn freely on a fixed countershaft or be a part of a countershaft that itself rotates on bearings.

In rear-wheel-drive manual transmissions, frequently, the input and output shafts lie along the same rotation axis. In many rear-wheel-drive transmissions the input and output shafts can be locked together to create a 1:1 gear ratio, causing the power flow to bypass the countershaft and provide a direct drive. The transmission input shaft has at least one pinion gear, which drives the countershaft. The countershaft gears correspond to transmission's forward speeds and its reverse. Each of the forward gears on the countershaft is permanently meshed with a corresponding driven gear on the output shaft. The forward driven gears are not rigidly attached to the output shaft—although the output shaft runs through the driven gears, these gears can spin on bearings independently of the output shaft.

Most modern manual-transmissions are fitted with synchronizers manipulated by shift forks. Each synchronizer is configured to match a speed of the forward driven gear being selected to that of the output shaft prior to its engagement. Reverse is typically provided via a pair of gears—one gear on the countershaft and one on the output shaft. However, whereas all the forward gears are always meshed together, there is typically a gap between the reverse gears. Furthermore, the reverse gears are attached to their respective shafts, i.e., neither one rotates freely relative to the shaft. When reverse is selected, an idler gear is slid between the pair of reverse gears. The idler gear has teeth, which mesh with both reverse gears to couple the reverse gears together and reverse the direction of gear rotation without changing the gear ratio.

Front-wheel-drive transmissions for transverse mounting of the engine in the vehicle are generally designed somewhat differently from rear-wheel-drive transmissions. Front-wheel-drive transmissions typically have an integral final drive and differential, and they usually have only two parallel shafts—an input shaft and a countershaft, sometimes called input and output. The input shaft runs the entire length of the transmission, and there is no separate input pinion. At the end of the countershaft is a pinion gear that meshes with a ring gear on a differential. Generally, however, front-wheel and rear-wheel-drive transmissions operate similarly. When the transmission is put in neutral and one or more input clutches are disengaged, the input shaft and the countershaft can continue to rotate under their own inertia. When the transmission is in neutral, each of the power source, such as an internal combustion engine, the input shaft along with the input clutch, and the output shaft can rotate independently.

In contemporary motor vehicles, operation of such parallel-shaft transmissions can be automated, i.e., selection of forward gears and operation of the input clutches can be regulated by a programmable controller. Such automated operation of the parallel-shaft transmission can free an operator of the vehicle from having to shift gears manually.

### SUMMARY

A transmission assembly for mounting to an external power-source includes an input shaft configured to receive a torque input from the external power-source. The transmission assembly also includes an output member configured to transmit a transmission output torque to drive a load. The transmission assembly additionally includes a countershaft driven by and arranged parallel to the input shaft. The countershaft has a first gear-set rotatably mounted thereon and is configured to drive the output member. The transmission assembly also includes a second gear-set in mesh with the first gear-set and operatively connected to the output member. Furthermore, the transmission assembly includes an electric motor configured to be selectively connected to the input shaft via a first torque transfer device and to the output member via a second torque transfer device to thereby provide a variable electric motor internal torque input to the transmission assembly.

At least one of the first torque transfer device and the second torque transfer device can be a synchronizer or a dog-clutch.

The transmission assembly can also include a transmission housing configured to be mounted to the power-source and retain each of the input shaft, the output member, the countershaft, the electric motor, and the first and second torque transfer devices. In such a case, the electric motor can include a stator fixed to the transmission housing and a rotor fixed to a rotor shaft, and each of the first and second torque transfer devices can be mounted to the rotor shaft.

A first rotor gear can be operatively connected to the input shaft for constant rotation therewith. A second rotor gear can be operatively connected to the output member for constant rotation therewith. Additionally, the first torque transfer device can be configured to rotatably fix the rotor to the first rotor gear and the second torque transfer device can be configured to rotatably fix the rotor to the second rotor gear.

The first torque transfer device being disengaged from the first rotor gear together with the second torque transfer device being disengaged from the second rotor gear can permit solely the power-source torque to be received by the input shaft.

The first torque transfer device being disengaged from the first rotor gear together with the second torque transfer device being engaged with the second rotor gear can transmit the internal torque input from the electric motor to the output member.

The first torque transfer device being engaged with the first rotor gear together with the second torque transfer device being disengaged from the second rotor gear can transmit the internal torque input from the electric motor to the input shaft.

The transmission assembly can additionally include a differential assembly. In such a case, the output member can be configured as a ring gear for the differential assembly. Additionally, in such a case, the rotor shaft can be arranged parallel to each of the input shaft and the countershaft, and the countershaft can be operatively connected to the differential assembly. Such a configuration of the transmission assembly can be employed in a front-wheel-drive (FWD) motor vehicle.

The output member can be configured as an output shaft arranged either in line or in parallel with the rotor shaft and the input shaft. Such a configuration of the transmission assembly can be employed in a rear-wheel-drive (RWD) motor vehicle.

The input shaft can include an odd gear shaft and an even gear shaft arranged concentrically with respect to one another and configured to be alternately engaged to selectively receive the power-source torque. In such a case, the transmission assembly can be configured as a dual-clutch transmission (DCT).

Also, at least one input clutch can be configured to operatively connect the power-source to the transmission assembly. The at least one input clutch can include a first clutch and a second clutch, and the odd-gear shaft and the even-gear shaft can be alternatively engaged via the first clutch and the second clutch, respectively, to selectively receive the power-source torque.

A motor vehicle having such a transmission and power-source is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of a vehicle employing a front-wheel-drive powertrain having a parallel-shaft automated transmission externally mounted to a power-source depicted as an internal combustion engine according to the disclosure.

FIG. 2 is a schematic illustration of a vehicle employing a rear-wheel-drive embodiment of the powertrain having the parallel-shaft automated transmission according to the disclosure.

FIG. 3 is a diagrammatic illustration of a single input clutch embodiment of the parallel-shaft automated transmission for the front-wheel-drive powertrain shown in FIG. 1.

FIG. 4 is a diagrammatic illustration of the single input clutch embodiment of the parallel-shaft automated transmission for the rear-wheel-drive powertrain shown in FIG. 2.

FIG. 5 is a diagrammatic illustration of a dynamically-shiftable, dual-clutch transmission (DCT) embodiment of the parallel-shaft automated transmission for the front-wheel-drive powertrain shown in FIG. 1.

FIG. 6 is a diagrammatic illustration of the DCT embodiment of the parallel-shaft automated transmission for the rear-wheel-drive powertrain shown in FIG. 2.

### DETAILED DESCRIPTION

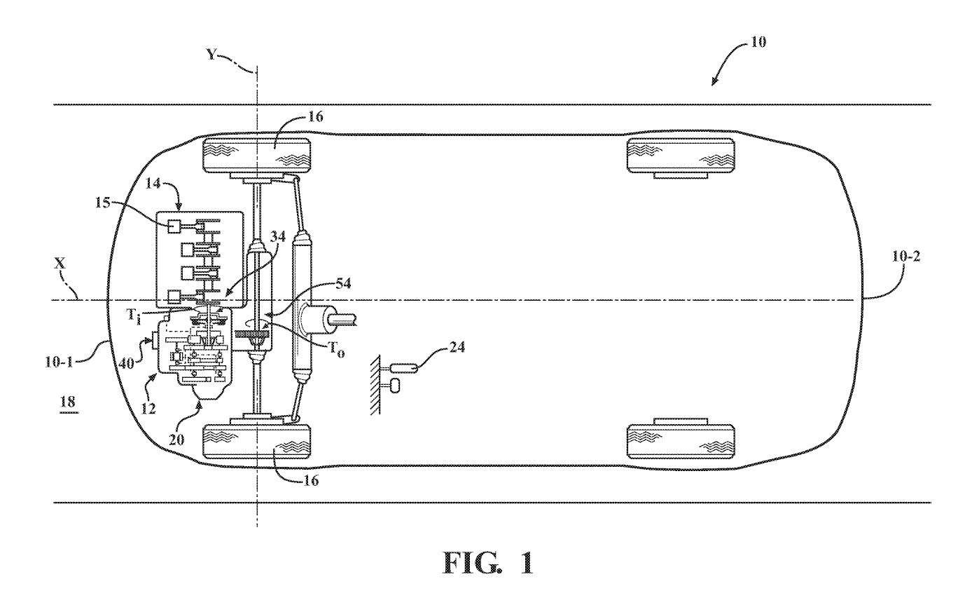

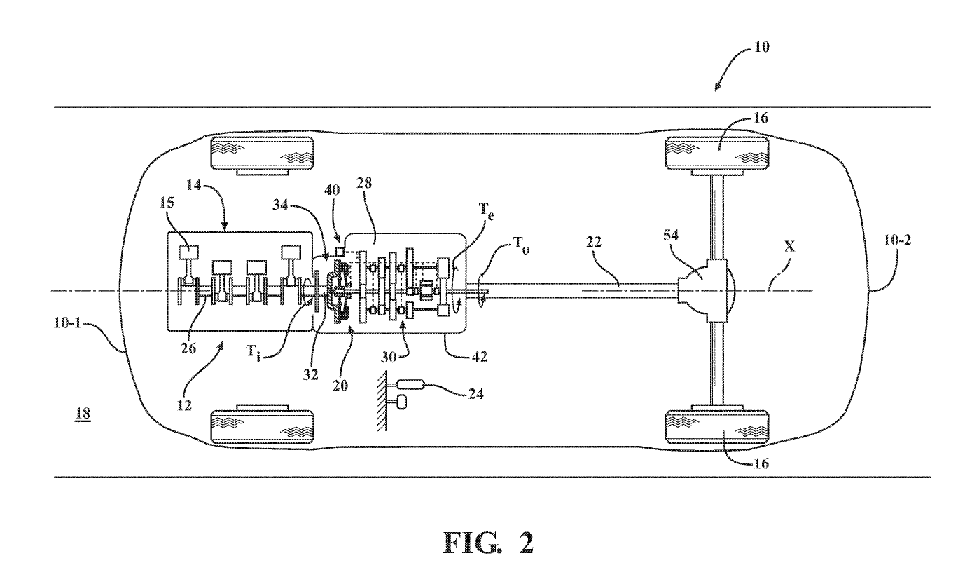

Referring to FIGS. 1 and 2, a vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be any mobile platform, such as an airplane, all-terrain vehicle (ATV), boat, personal movement apparatus, robot and the like to accomplish the purposes of this disclosure.

The powertrain 12 includes a power-source 14 configured to generate torque Tᵢ for propulsion of the vehicle 10 via driven wheels 16 relative to a road surface 18. The powertrain 12 also includes a transmission assembly 20 operatively connected to the power-source 14, i.e., externally mounted to the power-source and configured to transfer the torque Tᵢ generated by the power-source to the driven wheels 16. The transmission assembly 20 is further configured to receive, and then multiply or reduce the torque Tᵢ to achieve a resultant transmission output torque Tₒ. The driven wheels 16 can be operatively connected to the transmission assembly 20, such as via a drive shaft 22, and configured to receive the transmission output torque Tₒ. A vehicle accelerator 24, such as a pedal or a lever, is provided for a vehicle operator in order to control the engine torque Tᵢ to drive the vehicle 10.

The power-source 14 can include an internal combustion engine, a fuel-cell, and/or an electric motor (not shown) mounted in the vehicle 10 and having the transmission assembly 20 mounted externally thereto. However, for conciseness and clarity, the present disclosure will concentrate on the embodiment of the power-source 14 that includes solely the internal combustion engine. Accordingly, although the numeral 14 should be seen as generally attributable to any and all embodiments of the envisioned powertrain, for the remainder of the present disclosure, the numeral 14 will be used to denote the specific embodiment of the powertrain having solely the internal combustion engine. As such, the power-source input torque Tᵢ will be hereinafter referenced as engine 14 torque. As shown, the particular engine 14 includes a crankshaft 26 for converting reciprocal motion of its pistons 15 into rotational motion and generating the input torque Tᵢ, as is understood by those skilled in the art.

The transmission assembly 20 is paired with the engine 14 at an engine-transmission interface using any appropriate means, including fasteners (not shown), such as threaded screws and dowels. The transmission assembly 20 includes a transmission housing or case 28 for retaining a gear-train 30 configured to provide a predetermined number of selectable gear ratios for operatively connecting the engine crankshaft 26 to the driven wheels 16. The transmission assembly 20 also includes an input shaft 32 configured to receive the engine 14 torque Tᵢ and transfer the subject torque to the gear-train 30. At least one input clutch 34 is arranged between the crankshaft 26 and the input shaft 32 to operatively connect the engine 14 to the transmission assembly 20 and selectively transfer the engine 14 torque Tᵢ to the gear-train 30. The transmission assembly 20 also includes an output member 36 configured to transmit the transmission output torque Tₒ to drive a load, i.e., the road wheels 16.

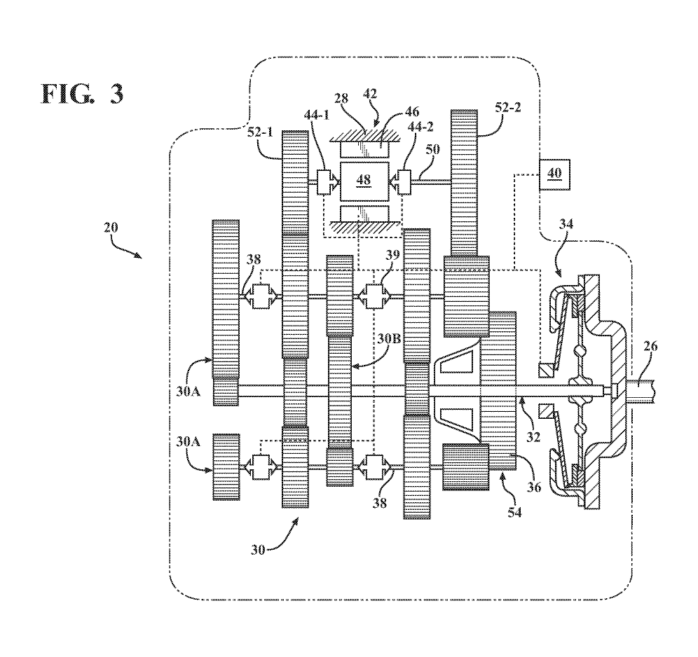

As can be seen in FIGS. 3-6, the transmission assembly 20 also includes one or more countershafts 38 driven by and arranged parallel to the input shaft 32. Accordingly, the transmission assembly 20 is configured as a parallel-shaft transmission. In general, the term “parallel-shaft” is a term of art denoting a type of an arrangement of the gear-train 30 that positions various meshed gears employed to select transmission gear ratios on separate, parallel shafts. Although parallel-shaft arrangement as in the transmission gear-train 30 is commonly employed by both manual and automated manual transmissions, as will be discussed in detail, the present disclosure is specifically applicable to automated parallel-shaft transmissions. The countershafts 38 include a first gear-set 30A portion of the gear-train 30. The first gear-set 30A is rotatably mounted on a countershaft 38, i.e., the individual gears of the first gear-set 30A may either turn freely on a fixed countershaft or be part of a countershaft configured to rotate relative to the transmission housing 28. A second gear-set 30B portion of the gear-train 30 is in mesh with the first gear-set 30A and is operatively connected to the output member 36. As shown, the second gear-set 30B portion of the gear-train 30 can be mounted to the input shaft 32 or to the output member 36. The first gear-set 30A is configured to drive the output member 36 via selective engagement of individual gears of the second gear-set 30B via locking thereof to the output member by specifically configured synchronizers 39.

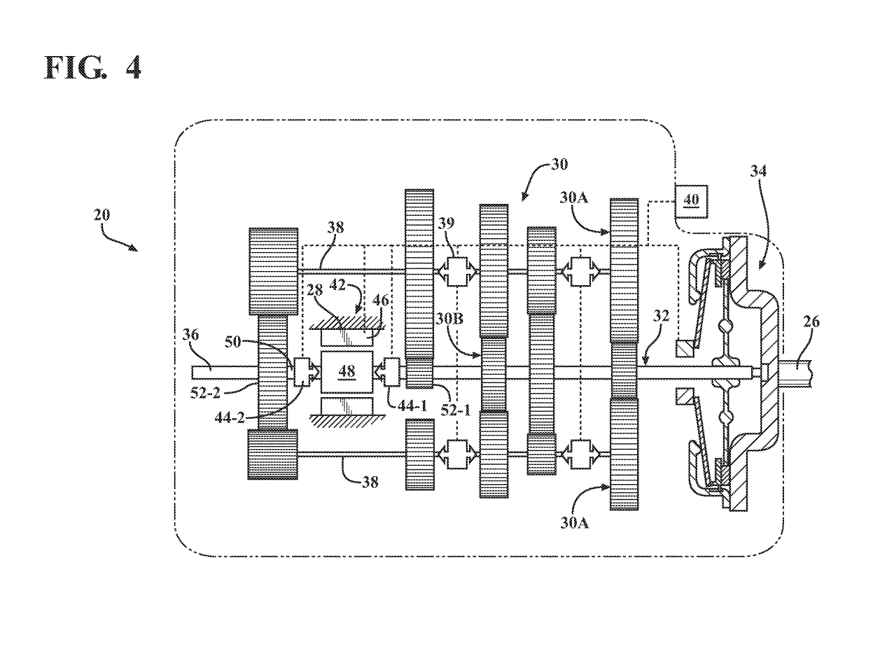

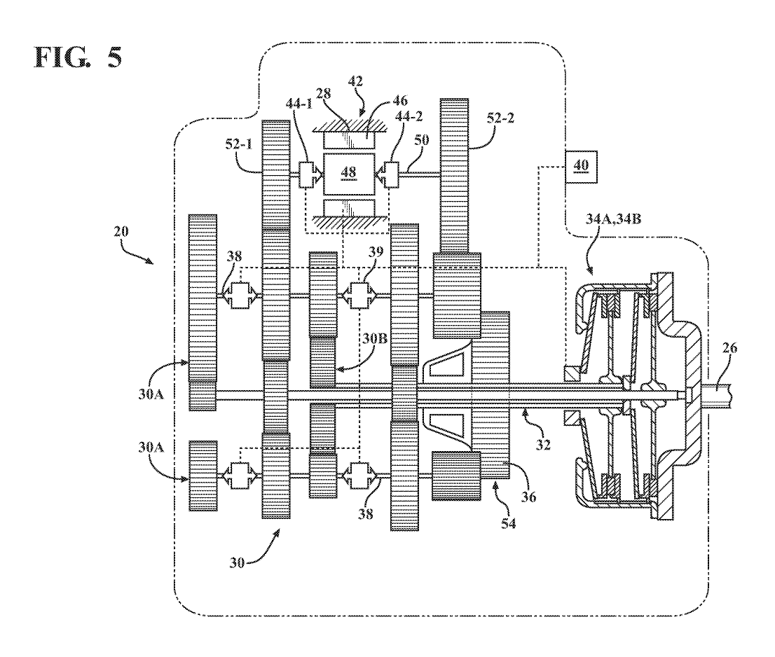

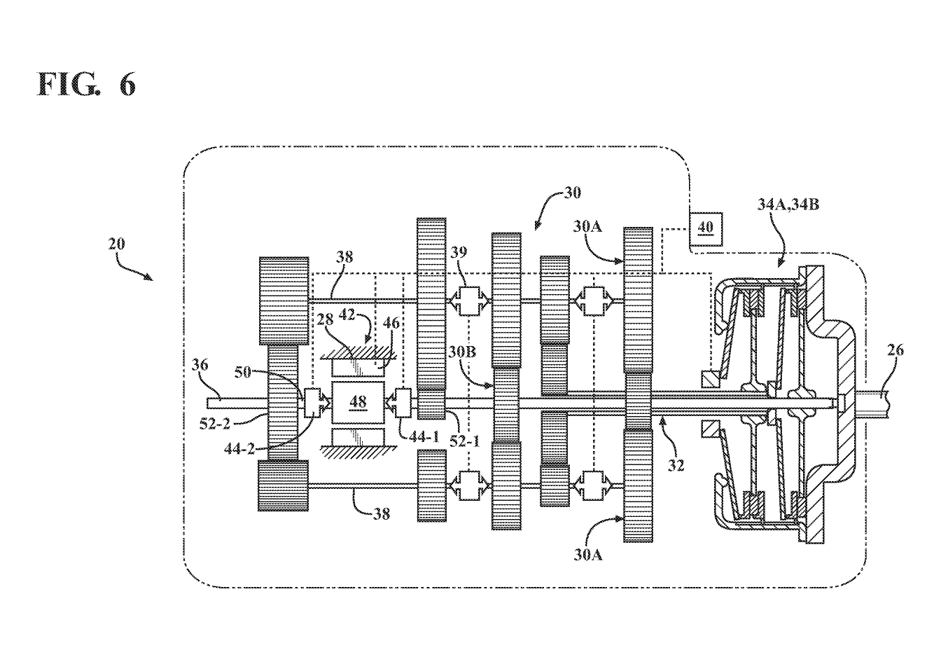

One embodiment of the transmission assembly 20 can employ a single input clutch 34 configured to selectively transfer the torque Tᵢ to the input shaft 32, shown in FIGS. 3 and 4. Another embodiment of the transmission assembly 20 can be a dynamically-shiftable multi-speed multiple input clutch transmission. A particular embodiment of the multi-speed multiple input clutch transmission is the currently widespread dual-clutch transmission (DCT), shown in FIGS. 5 and 6. As understood by those skilled in the art, a DCT employs two input clutches 34, specifically a first input clutch 34A and a second input clutch 34B. In such an embodiment, the input shaft 32 includes an odd-gear shaft 32A and an even-gear shaft 32B arranged concentrically with respect to one another and configured to be alternately engaged via respective input clutches 34A and 34B to selectively receive the engine 14 torque Tᵢ.

With respect to the multi-speed multi-clutch transmission embodiment of the transmission assembly 20, the term “dynamically-shiftable” relates to the transmission assembly employing a combination of multiple input clutches 34, specifically shown as 34A and 34B in FIGS. 5 and 6, and several synchronizers 39 (or dog clutches) to achieve “power-on” or dynamic shifts by alternating between engagement of the respective input clutches. Additionally, “dynamic shifting” means that drive torque is present in the transmission assembly 20 when a clutched shift to an oncoming speed ratio is made. Generally, the synchronizers 39 are physically “pre-selected” for the oncoming ratio prior to actually making the dynamic shift. As will be readily understood by those skilled in the art, prior to making a “dynamic shift”, appropriate synchronizers 39 are “pre-selected” to the necessary positions of both the oncoming and off-going ratios prior to actually shifting the torque path from one input clutch to another.

Either the single input clutch or the multiple input clutch embodiment of the transmission assembly 20 disclosed above can be employed in a front-wheel-drive (FWD) powertrain architecture of the vehicle 10 (shown in FIGS. 1, 3, and 5) or a rear-wheel-drive (RWD) powertrain architecture (shown in FIGS. 2, 4, and 6). According to the present disclosure, operation of the parallel-shaft transmission assembly 20 is automated, i.e., can be controlled to automatically change gear ratios as the vehicle moves relative to the road surface 18, freeing an operator or driver of the vehicle 10 from having to shift gears manually. Such automation of the transmission assembly 20 can be regulated by a programmable controller 40. The controller 40 may include a central processing unit (CPU) that regulates various functions on the vehicle 10 or be configured as a dedicated electronic control unit (ECU) for the powertrain 12. In either configuration, the controller 40 includes a processor and tangible, non-transitory memory, which includes instructions for operation of the transmission assembly 20 programmed therein. The memory may be any recordable medium that participates in providing computer-readable data or process instructions. Such a medium may take many forms, including but not limited to non-volatile media and volatile media.

Non-volatile media for the controller 40 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer. Memory of the controller 40 may also include a floppy disk, a flexible disk, hard disk, magnetic tape, any other magnetic medium, a CD-ROM, DVD, any other optical medium, etc. The controller 40 can be configured or equipped with other required computer hardware, such as a high-speed clock, requisite Analog-to-Digital (A/D) and/or Digital-to-Analog (D/A) circuitry, any necessary input/output circuitry and devices (I/O), as well as appropriate signal conditioning and/or buffer circuitry. Any algorithms required by the controller 40 or accessible thereby may be stored in the memory and automatically executed to provide the required functionality.

The transmission assembly 20 also includes an electric motor 42 configured to be selectively connected to the input shaft 32 via a first torque transfer device 44-1 and to the output member 36 via a second torque transfer device 44-2. Accordingly, in addition to retaining the gear-train 30, the input shaft 32, the output member 36, the countershaft 38, along with a specially formulated transmission lubricant, the transmission housing 28 is configured to retain the electric motor 42 and the first and second torque transfer devices 44-1, 44-2. Either or both of the first torque transfer device 44-1 and the second torque transfer device, 44-2 can be configured as a synchronizer or a dog-clutch. Such selective operation of the first torque transfer device 44-1 and the second torque transfer device 44-2 is intended to provide an internal variable electric motor torque input Tₑ to the transmission assembly 20. Additionally, the electric motor 42 itself and the first and second torque transfer devices 44-1, 44-2 can be controlled via the controller 40 to provide an electric drive for the vehicle 10 or an electric torque assist to the engine 14.

As shown in FIGS. 3-6, the electric motor 42 includes a stator 46 that can be fixed to the transmission housing 28 and a rotor 48 that can be fixed to a rotor shaft 50. Each of the first and second torque transfer devices 44-1, 44-2 is mounted to the rotor shaft 50. As additionally shown, the transmission assembly 20 also includes a first rotor gear 52-1 and a second rotor gear 52-2. The first rotor gear 52-1 is operatively connected to the input shaft 32 for constant, i.e., simultaneous, rotation therewith. Similarly, the second rotor gear 52-2 is operatively connected to the output member for constant rotation therewith. The first torque transfer device 44-1 is configured to rotatably fix the rotor 48 to the first rotor gear 52-1 and the second torque transfer device 44-2 is configured to rotatably fix the rotor to the second rotor gear 52-2.

Whether the first torque transfer device 44-1 or the second torque transfer device 44-2 is engaged depends on whether it is desirable for the transmission assembly's gear-train 30 to be used for multiplication (or reduction) of the electric motor torque input Tₑ in achieving the desired transmission torque Tₒ. Specifically, if the first torque transfer device 44-1 is engaged while the second torque transfer device 44-2 is disengaged, the electric motor torque input Tₑ can be modified via the gear-train 30. On the other hand, if the first torque transfer device 44-1 is disengaged while the second torque transfer device 44-2 is engaged, the electric motor torque input Tₑ can be transmitted directly to the output member 36, bypassing the gear-train 30.

During operation of the transmission assembly 20, the first torque transfer device 44-1 being disengaged from the first rotor gear 52-1 together with the second torque transfer device 44-2 being disengaged from the second rotor 52-2 gear permits solely the engine 14 torque Tᵢ to be received by the input shaft 32. In such a case, if the single input clutch 34 or one of the first and second input clutches 34A, 34B, depending on the specific embodiment of the transmission assembly 20 described above, is engaged, the transmission assembly can receive the engine 14 torque Tᵢ. On the other hand, if the input clutch 34 or none of the first and second input clutches 34A, 34B in the respective embodiments of the transmission assembly 20 is engaged, the transmission assembly will be in neutral, where no torque flows therethrough.

Additionally, the first torque transfer device 44-1 being disengaged from the first rotor gear 52-1 together with the second torque transfer device 44-2 being engaged with the second rotor gear 52-2 transmits the internal motor torque input Tₑ to the output member 36. In such a case, depending on the specific embodiment of the transmission assembly 20, if the single input clutch 34 or one of the first and second input clutches 34A, 34B is engaged, the internal motor torque input Tₑ provides an electric torque assist to the engine 14 torque Tᵢ. Furthermore, the first torque transfer device 44-1 being engaged with the first rotor gear 52-1 together with the second torque transfer 44-2 device being disengaged from the second rotor gear 52-2 transmits the internal motor torque input Tₑ to the input shaft 32.

In a particular embodiment of the vehicle 10 shown in FIG. 1, the powertrain 12 can be mounted transversely in the vehicle 10, where an axis Y extending along the crankshaft 26 of the engine 14 and the input shaft 32 of the transmission assembly 20 is arranged at approximately 90 degrees relative to a longitudinal axis X of the vehicle. As understood by those skilled in the art, such a transverse mounting of the powertrain 12 is typically employed in FWD vehicles, where the driven road wheel(s) 16 are arranged proximate a front end 10-1 of the vehicle 10. Such a transversely mounted transmission assembly 20 can additionally include a differential assembly 54, and is then, generally, described as a transaxle. In the subject transversely mounted transmission assembly 20, the output member 36 can be configured as a ring gear (shown in FIGS. 3 and 5) for the differential assembly 54. Furthermore, the rotor shaft 50 can be arranged parallel to each of the input shaft 32 and the countershaft 38, while the countershaft is operatively connected to the differential assembly 54, such as directly meshed with the ring gear output member 36.

In another embodiment of the vehicle 10 shown in FIG. 2, the powertrain 12 can be mounted longitudinally in the vehicle, where the axis X of the vehicle extends along the crankshaft 26 of the engine 14 and the input shaft 32 of the transmission assembly 20. As understood by those skilled in the art, such a longitudinal mounting of the powertrain 12 is typically employed in RWD vehicles, where the driven road wheel(s) 16 are arranged at a rear end 10-2 of the vehicle 10, as shown in FIG. 2. In such a longitudinally mounted transmission assembly 20, the output member 36 can be configured as an output shaft arranged either in-line or in parallel with the rotor shaft 50 and the input shaft 32 (shown in FIGS. 4 and 6). Furthermore, as shown in FIG. 2, in the RWD powertrain 12 architecture, the differential assembly 54 is arranged separately from the transmission assembly 20, between the driven wheels 16, aft of the driveshaft 22. Any embodiment of the transmission assembly 20 shown in FIGS. 3-6 can be employed in an all- or a four-wheel-drive vehicle (not shown), where all the road wheels 16 are driven via the resultant transmission torque Tₒ. The specific embodiment of the transmission assembly 20, whether of FIGS. 3 and 5 or of FIGS. 4 and 6, to be employed in a particular all- or four-wheel-drive vehicle will generally depend on whether the powertrain 12 is mounted transversely or longitudinally in the subject vehicle 10.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A transmission assembly for mounting to an external power-source and transmitting a power-source torque therefrom, the transmission assembly comprising:
an input shaft configured to receive the power-source torque;
an output member configured to transmit a transmission output torque to drive a load;
a countershaft driven by and arranged parallel to the input shaft, wherein the countershaft has a first gear-set rotatably mounted thereon and is configured to drive the output member;
a second gear-set in mesh with the first gear-set and operatively connected to the output member; and
an electric motor configured to be selectively connected to the input shaft via a first torque transfer device and to the output member via a second torque transfer device to thereby provide a variable electric motor torque input to the transmission assembly.

2. The transmission assembly according to claim 1, wherein at least one of the first torque transfer device and the second torque transfer device is a synchronizer.

3. The transmission assembly according to claim 1, wherein at least one of the first torque transfer device and the second torque transfer device is a dog-clutch.

4. The transmission assembly according to claim 1, further comprising a transmission housing configured to be mounted to the power-source and retain each of the input shaft, the output member, the countershaft, the electric motor, and the first and second torque transfer devices, wherein:
the electric motor includes a stator fixed to the transmission housing and a rotor fixed to a rotor shaft;
each of the first and second torque transfer devices is mounted to the rotor shaft;
a first rotor gear is operatively connected to the input shaft for constant rotation therewith;
a second rotor gear is operatively connected to the output member for constant rotation therewith; and
the first torque transfer device is configured to rotatably fix the rotor to the first rotor gear and the second torque transfer device is configured to rotatably fix the rotor to the second rotor gear.

5. The transmission assembly according to claim 4, wherein the first torque transfer device being disengaged from the first rotor gear together with the second torque transfer device being disengaged from the second rotor gear permits solely the power-source torque to be received by the input shaft.

6. The transmission assembly according to claim 4, wherein the first torque transfer device being disengaged from the first rotor gear together with the second torque transfer device being engaged with the second rotor gear transmits the internal torque input from the electric motor to the output member.

7. The transmission assembly according to claim 4, wherein the first torque transfer device being engaged with the first rotor gear together with the second torque transfer device being disengaged from the second rotor gear transmits the internal torque input from the electric motor to the input shaft.

8. The transmission assembly according to claim 4, further comprising a differential assembly, wherein the output member is configured as a ring gear for the differential assembly, wherein the rotor shaft is arranged parallel to each of the input shaft and the countershaft, and wherein the countershaft is operatively connected to the differential assembly.

9. The transmission assembly according to claim 4, wherein the output member is configured as an output shaft arranged one of in-line and parallel with the rotor shaft and the input shaft.

10. The transmission assembly according to claim 1, wherein the input shaft includes an odd-gear shaft and an even-gear shaft arranged concentrically with respect to one another and configured to be alternately engaged to selectively receive the power-source torque.

11. A vehicle comprising:
a power-source configured to generate a power-source torque;
a transmission assembly mounted externally to the power-source and configured to transmit the power-source torque;
at least one input clutch configured to operatively connect the power-source to the transmission assembly; and
a road wheel configured to receive the power-source torque transmitted by the transmission;
wherein the transmission assembly includes:
an input shaft configured to receive the power-source torque via the at least one input clutch;
an output member configured to transmit a transmission output torque to the road wheel;
a countershaft driven by and arranged parallel to the input shaft, wherein the countershaft has a first gear-set rotatably mounted thereon and is configured to drive the output member;
a second gear-set in mesh with the first gear-set and operatively connected to the output member; and
an electric motor configured to be selectively connected to the input shaft via a first torque transfer device and to the output member via a second torque transfer device to thereby provide a variable electric motor torque input to the transmission assembly.

12. The vehicle according to claim 11, wherein at least one of the first torque transfer device and the second torque transfer device is a synchronizer.

13. The vehicle according to claim 11, wherein at least one of the first torque transfer device and the second torque transfer device is a dog-clutch.

14. The vehicle according to claim 11, wherein the transmission assembly additionally includes a transmission housing mounted to the power-source and configured to retain each of the input shaft, the output member, the countershaft, the electric motor, and the first and second torque transfer devices, and wherein:
the electric motor includes a stator fixed to the transmission housing and a rotor fixed to a rotor shaft;
each of the first and second torque transfer devices is mounted to the rotor shaft;
a first rotor gear is operatively connected to the input shaft for constant rotation therewith;
a second rotor gear is operatively connected to the output member for constant rotation therewith; and
the first torque transfer device is configured to rotatably fix the rotor to the first rotor gear and the second torque transfer device is configured to rotatably fix the rotor to the second rotor gear.

15. The vehicle according to claim 14, wherein the first torque transfer device being disengaged from the first rotor gear together with the second torque transfer device being disengaged from the second rotor gear permits solely the power-source torque to be received by the input shaft.

16. The vehicle according to claim 14, wherein the first torque transfer device being disengaged from the first rotor gear together with the second torque transfer device being engaged with the second rotor gear transmits the internal torque input from the electric motor to the output member.

17. The vehicle according to claim 14, wherein the first torque transfer device being engaged with the first rotor gear together with the second torque transfer device being disengaged from the second rotor gear transmits the internal torque input from the electric motor to the input shaft.

18. The vehicle according to claim 14, wherein:
the transmission assembly additionally includes a differential assembly;
the output member is configured as a ring gear for the differential assembly; and
the rotor shaft is arranged parallel to each of the input shaft and the countershaft, and wherein the countershaft is operatively connected to the differential assembly.

19. The vehicle according to claim 14, wherein the output member is configured as an output shaft arranged one of in-line and parallel with the rotor shaft and the input shaft.

20. The vehicle according to claim 11, wherein the at least one input clutch includes a first clutch and a second clutch, and wherein the input shaft includes an odd-gear shaft and an even-gear shaft arranged concentrically with respect to one another and configured to be alternately engaged via the first clutch and the second clutch, respectively, to selectively receive the power-source torque.
